(19) United States
(12) Patent Application Publication
(10) Pub. No.: US 2025/0330677 A1
(43) Pub. Date: Oct. 23, 2025

(54) SYSTEM AND METHOD FOR DYNAMIC IOT MULTI-DEVICE AUTOMATION GENERATION FOR REAL/VIRTUAL WORLD ENVIRONMENT

(71) Applicant: SAMSUNG ELECTRONICS CO., LTD., Suwon-si (KR)

(72) Inventors: Piyush CHOMAL, Bengaluru (IN); Kumar Dhananjay DUBEY, Bengaluru (IN); Vinod Reddy MOPURU, Bengaluru (IN)

(73) Assignee: SAMSUNG ELECTRONICS CO., LTD., Suwon-si (KR)

(21) Appl. No.: 19/197,468

(22) Filed: May 2, 2025

Related U.S. Application Data
(63) Continuation of application No. PCT/KR2025/002735, filed on Feb. 27, 2025.

(30) Foreign Application Priority Data
Apr. 23, 2024 (IN) 202441032152

(51) Int. Cl. H04N 21/466

(52) U.S. Cl. CPC H04N 21/4662; H04N 21/4667

(57) ABSTRACT

A method for creating automations for interactions of a plurality of electronic devices may include receiving a user input including user intents from a user, generating, using a generative model based on the user input, a list of activities to be executed in connection with the user intents, identifying, using the generative model, a plurality of entities that are required to perform the activities, predicting an execution plan including a plurality of automations to be carried out the activities, based on relations between the activities and the plurality of entities for triggering the plurality of automations via the plurality of electronic devices, mapping a corresponding electronic device among the plurality of electronic devices with a corresponding entity among the plurality of entities based on the execution plan, and triggering, based on the mapping, the plurality of automations in a sequence upon occurrence of events in connection with the activities.

### CROSS-REFERENCE TO RELATED APPLICATION

This application is a continuation application of International Patent Application No. PCT/KR2025/002735, filed on Feb. 27, 2025, which claims priority from Indian Patent Application No. 202441032152, filed on Apr. 23, 2024, the disclosures of which are incorporated herein by reference in their entireties.

### BACKGROUND

### 1. Field

The present disclosure relates to a field of Internet of Things (IoT), specifically to smart personal assistants or artificial intelligence (AI)-powered virtual assistants that interact with IoT devices. In particular, the present disclosure relates to a method and a system for dynamically generating autonomous operations for a plurality of IoT devices in a real or virtual environment.

### 2. Description of Related Art

The rapid proliferation of IoT devices has ushered in a new era where our everyday interactions with technology are becoming increasingly interconnected. With users now owning a plurality of IoT devices (may also be referred to as IoT multi-devices), each designed for specific purposes, expectations of how the plurality of IoT devices should interact and provide a seamless experience have dramatically increased. The users are seeking harmonious interactions and a diverse range of personalized experiences using the plurality of IoT devices that could range from home automation, organizing events, media entertainment, to interactive learning and more.

However, conventional solutions lack in supporting the design and execution of autonomous operations for the plurality of IoT devices. Especially when the conventional solutions require complex coordination, dynamic context-aware operations, generation of custom media, and crafting of immersive environments involving real and virtual worlds, for the plurality of IoT devices, the users find it challenging to fully utilize the functionalities of the plurality of IoT devices to meet their diverse and sophisticated requirements.

FIG. 1 illustrates an example of IoT Multi-device Activity planning for complex user requirements, according to a conventional technique. FIG. 1 illustrates a system for showing the plurality of IoT devices interactions with a conventional smart speaker to enhance the welcoming experience for guests at a child's birthday party. For example, when the user asks the smart speaker “Assist me in creating an IoT multi-device activity for my son's birthday party,” the user may envision creating automated sequences that involve the plurality of IoT devices, such as lights, music, and projections, to create a cohesive and interactive ambiance. However, the conventional smart speaker may respond “Okay, you can use the lighting and music scenes in the IoT system app” instead of automatically executing the user's desired operations with the IoT devices. Thus, the user faces challenges in planning and sequencing these activities effectively. There is uncertainty about the optimal order for actions like turning on lights, playing welcome music, and projecting a welcome message. Despite having the plurality of IoT devices, the user lacks guidance and support from existing systems to plan and execute complex multi-device interactions seamlessly. The need for comprehensive assistance in orchestrating the dynamic interactions among the plurality of IoT devices becomes apparent in the absence of suitable guidance from conventional systems.

FIG. 2 illustrates another example of deriving synchronized IoT effects, according to a conventional technique. FIG. 2 illustrates that the user seeks an “Immersive movie mode” to enhance the home viewing experience. The user aims to establish a captivating cinematic ambiance at home, using the plurality of IoT devices that respond dynamically to the unfolding movie context. For example, when the user asks the smart speaker “Assist me in creating an immersive movie watching experience for XYZ movie,” the user may envision a sophisticated system capable of actively extracting contextual cues from the movie, discerning intense scenes, humorous moments, or significant dialogues, and subsequently orchestrating adjustments in lighting, sound, and even room temperature. However, the existing system may simply play the XYZ movie from Prime Video and fails to dynamically analyze media content, thereby falling short of the user's expectations to generate IoT effects aligned with the nuances of the movie context.

FIG. 3 illustrates another example of generating the multiple IoT device interactions involving many complex automations, according to a conventional technique. FIG. 3 illustrates that the user seeks to design a sophisticated “Home gardening Multi-Device Experience (MDE)” involving plurality of IoT devices. The user's objective is to establish a sophisticated multiple IoT device execution for the home garden task, encompassing activities such as watering, pest control, species-specific shading, and growth monitoring. For example, when the user asks the smart speaker “Assist me in creating an IoT multi-device automations for Home Gardening,” the user may expect multiple gardening-enabled IoT devices to work together seamlessly, by setting up watering schedules, customizing shading conditions based on the unique requirements of each plant species, and providing real-time monitoring of plant growth. However, the conventional IoT system proves insufficient in accommodating the intricacies involved in automating the diverse elements essential to creating a comprehensive and enriching home gardening experience.

FIG. 4 illustrates another example of generating automations for a plurality of IoT devices in multiple environments, according to a conventional technique. The user, in FIG. 4, desires to engage in a movie-watching experience within a virtual movie theatre using a Virtual Reality (VR) headset, while also incorporating specific real-world ambiance effects such as adjusting room temperature or introducing aromas. For example, when the user asks the smart speaker “Assist me in creating a Dynamic Media Environment (DME) automations for an immersive movie watching experience for XYZ movie in VR theater,” the user may seek a hybrid experience where certain automations, such as lighting ambiance, manifest within the virtual movie theatre, while others that are not feasible in the virtual realm are actualized in the real world. However, the existing conventional system may not support this hybrid configuration of real and virtual environments, consequently falling short of delivering a genuinely immersive movie-watching experience.

Therefore, in light of the above-mentioned challenges, a solution is required to overcome the above-mentioned challenges associated with the users for creating diverse, complex, and immersive multiple device automation using plurality of IoT devices and their capabilities.

### SUMMARY

According to an aspect of the present disclosure, a method for creating automations for interactions of a plurality of electronic devices, may include: receiving a user input including one or more user intents from a user; generating, using a pre-trained generative model based on the user input, a list of activities to be executed in connection with the one or more user intents; identifying, using the pre-trained generative model, a plurality of entities that are required to perform the activities; predicting, using the pre-trained generative model, an execution plan including a plurality of automations to be carried out the activities, based on relations between the activities and the plurality of entities for triggering the plurality of automations via the plurality of electronic devices; mapping a corresponding electronic device among the plurality of electronic devices with a corresponding entity among the plurality of entities based on the execution plan; and triggering, based on the mapping, the plurality of automations in a sequence upon occurrence of events in connection with the activities.

According to another aspect of the disclosure, a system for creating automations for interactions of a plurality of electronic devices may include: at least one processor; and a memory communicatively coupled with the at least one processor, wherein the at least one processor is configured to: receive a user input including one or more user intents; generate, using a pre-trained generative model based on the user input, a list of activities to be executed in connection with the one or more user intents; identify, using the pre-trained generative model, a plurality of entities that are required to perform the activities; predict, using the pre-trained generative model, an execution plan including a plurality of automations to be carried out for each activity based on relations between the activities and the plurality of entities for triggering autonomous operations via the plurality of electronic devices; map a corresponding electronic device among the plurality of electronic devices with a corresponding entity among the plurality of entities based on the execution plan; and trigger, based on the mapping, the plurality of automations in a sequence upon occurrence of events in connection with the activities.

According to another aspect of the disclosure, a method for providing artificial intelligence (AI)-based assistance, may include: receiving a user query that requests a task from a user; identifying a plurality of activities required to perform the task through an AI-based generative model by inputting a processing result of the user query to AI-based generative model; identifying a plurality of electronic devices configured to perform the plurality of actions, respectively; generating an execution plan that indicates activation times and operation methods for the plurality of electronic devices to execute the task; and transmitting commands to the plurality of electronic devices based on the execution plan.

The method may include: inputting the user query to an AI-based language model to obtain a follow-up query to identify user requirements associated with the task; outputting the follow-up query; receiving additional information regarding the user requirements from the user; and obtaining, as the processing result of the user query, context data and the user requirements for the task from the AI-based language model based on the additional information and the user query being input to the AI-based language model.

The AI-based generative model may include: a multi-head attention layer configured to attend to a plurality of contexts included in the processing result of the user query; and a long short-term memory (LSTM) configured to identify sequential dependencies among features output from the multi-head attention layer.

The generating the execution plan may include: determining contextual embeddings associated with the plurality of activities; modifying, using the AI-based generative model, the contextual embeddings and the plurality of activities into an actionable sequence; and generating the execution plan based on the actionable sequence for executing the plurality of activities via the plurality of electronic devices.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an example of IoT Multi-device Activity planning for complex user requirements, according to a conventional technique;

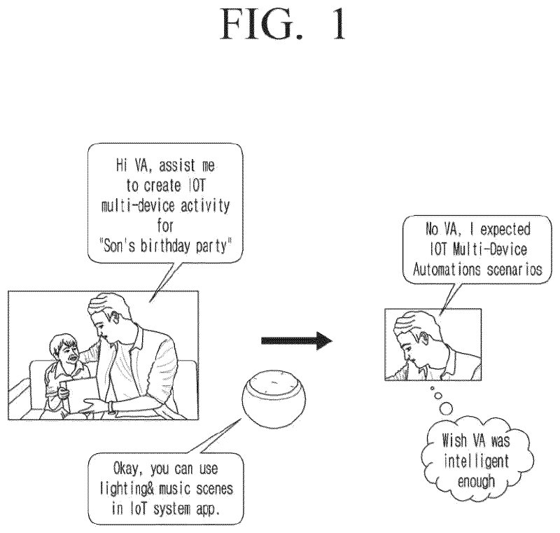

FIG. 2 illustrates another example of deriving synchronized IoT effects, according to a conventional technique;

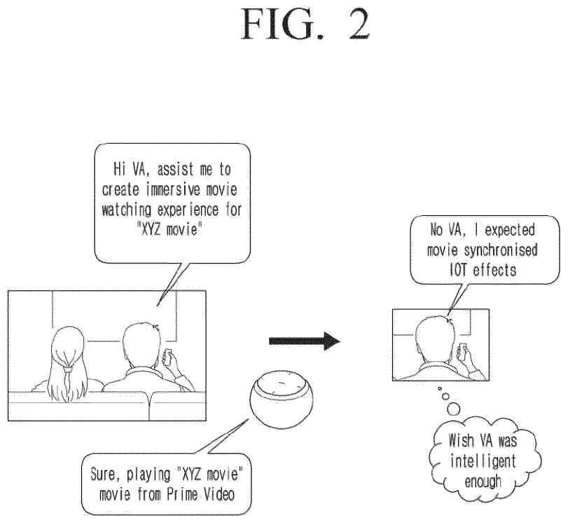

FIG. 3 illustrates another example of generating the multiple IoT device interactions involving many complex automations, according to a conventional technique;

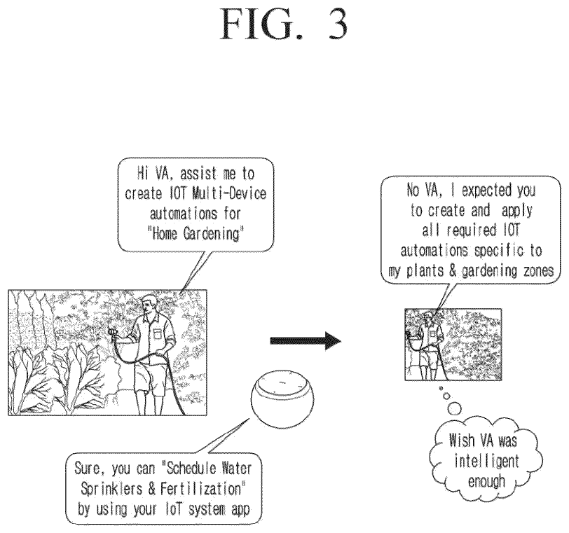

FIG. 4 illustrates another example of generating automations for a plurality of IoT devices in multiple environments, according to a conventional technique;

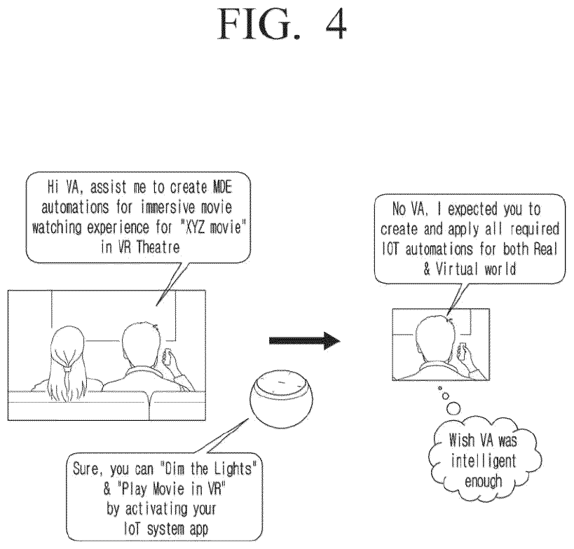

FIG. 5 illustrates a block diagram of a system for dynamic automations involving plurality of IoT devices, according to one or more embodiments of the present disclosure;

FIG. 6 illustrates an operational flow diagram 600 for the generation of dynamic automations involving the plurality of IoT devices, according to one or more embodiments of the present disclosure;

FIG. 7A illustrates a LLM-based model architecture, according to one or more embodiments of the present disclosure;

FIG. 7B illustrates a block diagram depicting a pipeline for training of Multi-Level IoT Activity Planner module by applying Supervised Fine-Tuning (SFT) and Reinforcement Learning from Human Feedback (RLHF), and/or RLAIF (Reinforcement Learning with AI Feedback), according to one or more embodiments of the present disclosure;

FIG. 7C illustrates a block diagram depicting a pipeline for inference using the Multi-Level IoT Activity Planner module, according to one or more embodiments of the present disclosure;

FIG. 7D illustrates a block diagram depicting a pipeline for training of Activity Automations generator module by applying SFT, RLHF, and/or RLAIF, according to one or more embodiments of the present disclosure;

FIG. 7E illustrates a block diagram depicting a pipeline for inference using the Activity Automations generator module, according to one or more embodiments of the present disclosure;

FIG. 7F illustrates a block diagram depicting a pipeline for training of Automation-Device Correlator module by applying SFT, RLHF, and/or RLAIF, according to one or more embodiments of the present disclosure;

FIG. 7G illustrates a block diagram depicting a pipeline for inference using the Automation-Device Correlator module, according to one or more embodiments of the present disclosure;

FIG. 8 illustrates a method for creating automations for interactions of a plurality of IoT devices, according to one or more embodiments of the present disclosure;

FIG. 9 illustrates a flow diagram of home gardening using IoT MDE Automations Generation, according to an exemplary embodiment of the present disclosure;

FIG. 10 illustrates a flow diagram of birthday party using IoT MDE Automations Generation, according to an exemplary embodiment of the present disclosure; and

FIG. 11 illustrates a flow diagram of immersive movie experience using IoT MDE Automations Generation, according to an exemplary embodiment of the present disclosure

Further, skilled artisans will appreciate that elements in the drawings are illustrated for simplicity and may not have necessarily been drawn to scale. For example, the flow charts illustrate the method in terms of the most prominent steps involved to help and improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The tern “some”, “one or more embodiment”, and “one or more example embodiments”, as used herein are defined as “one, or more than one, or all.” Accordingly, the terms “one,” “more than one,” “more than one, but not all” or “all” would all fall under the definition of “some.” The term “some embodiments” may refer to one embodiment, several embodiments, or to all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises”, “has”, “have”, and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features”, “one or more elements”, “at least one feature” or “at least one element.” Furthermore, the use of the terms “one or more” or “at least one” feature or element does not preclude there being none of that feature or element unless otherwise specified by limiting language such as “there needs to be one or more . . . ” or “one or more elements is required.”

The terms “A or B,” “at least one of A or/and B,” or “one or more of A or/and B” used in the various embodiments of the present disclosure include any and all combinations of words enumerated with it. For example, “A or B,” “at least one of A and B,” or “at least one of A or B” means (1) including at least one A, (2) including at least one B, or (3) including both at least one A and at least one B.

Although the terms such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

The expression “configured to (or set to)” used in various embodiments of the present disclosure may be replaced with “suitable for,” “having the capacity to,” “designed to,” “adapted to,” “made to,” or “capable of” according to the situation. The term “configured to (set to)” does not necessarily mean “specifically designed to” as hardware. Instead, the expression “apparatus configured to . . . ” may mean that the apparatus is “capable of . . . ” along with other devices or parts in a certain situation. For example, “a processor configured to (set to) perform A, B, and C” may be a dedicated processor, for example, an embedded processor, for performing a corresponding operation, or a generic-purpose processor, for example, a Central Processing Unit (CPU) or an application processor (AP), capable of performing a corresponding operation by executing one or more software programs stored in a memory device.

The term “module” used in the present document may imply a unit including, for example, one of hardware, software, and firmware or a combination of two or more of them. The “module” may be interchangeably used with a term such as a unit, a logic, a logical block, a component, a circuit, and the like. The “module” may be a minimum unit of an integrally constituted component or may be a part thereof. The “module” may be a minimum unit for performing one or more functions or may be a part thereof. The “module” may be mechanically or electrically implemented. For example, the “module” of the present disclosure may include at least one of an Application-Specific Integrated Circuit (ASIC) chip, a Field-Programmable Gate Arrays (FPGAs), and a programmable-logic device, which are known or will be developed and which perform certain operations.

The term “task” may refer to a goal or objective that may require several steps, actions, or activities to accomplish. A task may be considered a higher-level concept compared to activities, which are the individual actions, activities, or steps involved in completing the task. For example, “watering the garden” may be a task, and it may include multiple actions to be performed by electronic devices such as “check soil moisture,” “turn on irrigation system,” and “adjust water flow.”

Unless otherwise defined, all terms, and especially any technical and/or scientific terms, used herein may be taken to have the same meaning as commonly understood by one having ordinary skill in the art.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein.

As is traditional in the field, embodiments may be described and illustrated in terms of modules that carry out a described function or functions. These modules, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, third, etc. may be used herein to describe various elements, these elements should not be limited by these terms. These terms are generally only used to distinguish one element from another.

The terms “multiple IoT devices”, “plurality of IoT devices”, and “IoT multi-devices” may be used as synonyms interchangeably throughout the description without deviating from the scope of the present disclosure.

Embodiments of the present disclosure will be described below in detail with reference to the accompanying drawings.

One or more embodiments of the present disclosure provide users with a more streamlined and effortless approach to IoT scenarios and automations creation using the plurality of IoT devices based on a user requirement. By integrating environment-aware automations, the system and method disclosed in the present disclosure enable overcoming the manual work of planning multiple IoT automations for a specific user requirement. The present system and method further overcome setting up multiple IoT automations manually in the desired IoT system, and may further overcome triggering periodic or event-based automations.

In other words, the system and method disclosed in the present disclosure allow automatic generation of complex and personalized IoT activity plans based on user input/intent. The IoT activity plan lists activities and their related sub-activities, subsequently mapping these to multiple automations. Further, the system employs generative Artificial Intelligence (AI) which analyses user input, follows-up with the user with queries, understands the context of user's intent and requirements, and formulates a sequence of automations adapting with changing environment or system states, best fitting the user's requirements.

In one or more embodiments, the automations may include triggers and a series of device actions. The trigger may often involve a confluence of conditions that can be time-based, environment-based, system-based, or user activity-based. Further, automations act on these triggers (events) as well as on manual commands, as and when required.

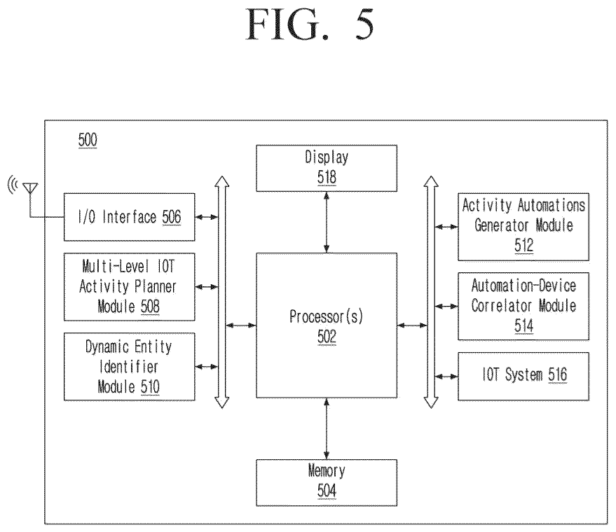

FIG. 5 illustrates a block diagram of a system 500 for dynamic automations involving the plurality of IoT devices, according to one or more embodiments of the present disclosure. The system 500 includes a processor(s) 502 (may also be referred to as “one or more processors 502” or “at least one processor 502”), a memory 504, an Input/Output (I/O) Interface 506, a multi-level IoT activity planner module 508, a dynamic entity identifier module 510, an activity automations generator module 512, an automation-device correlator module 514, an IoT system 516, and a display 518.

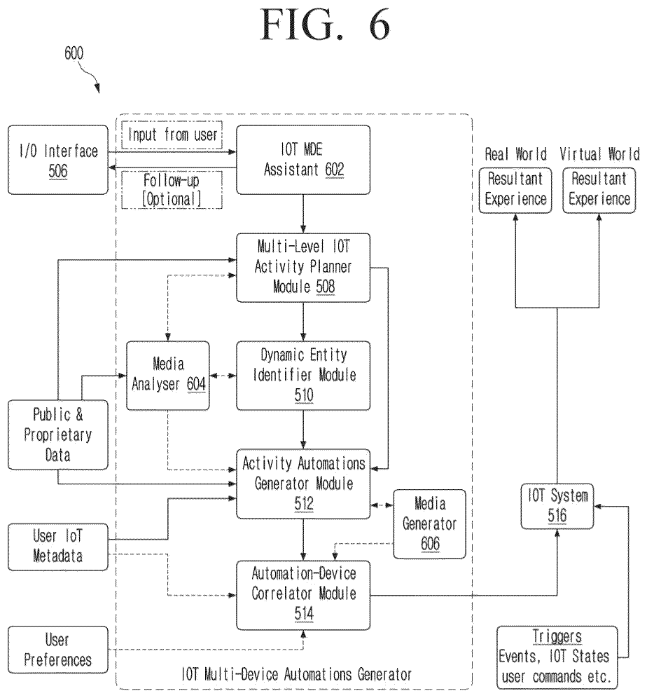

The processor 502 may be implemented as one or more microprocessors, microcomputers, microcontrollers, digital signal processors, central processing units, state machines, logic circuitries, and/or any devices that manipulate signals based on operational instructions. Among other capabilities, the processor 502 is configured to fetch and execute computer-readable instructions and data stored in the memory 504. At this time, the processor 502 may be a general-purpose processor, such as a central processing unit (CPU), an application processor (AP), or the like, and an AI-dedicated processor such as a neural processing unit (NPU). The processor 502 may control the processing of input data in accordance with a predefined operating rule or artificial intelligence (AI) model stored in the non-volatile memory and the volatile memory (e.g., the memory 504). The predefined operating rule or artificial intelligence model is provided through training or learning. Further, the processor 502 may be operatively coupled to each of the memory 504, the i/O Interface 506, the multi-level IoT activity planner module 508, the dynamic entity identifier module 510, the activity automations generator module 512, the automation-device correlator module 514, the IoT system 516, and the display 518. The processor 502 may be configured to process, execute, or perform a plurality of operations described herein below in conjunction with FIGS. 6-9 of the drawings.

The memory 504 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 504 is communicatively coupled with the processor 502 to store processing instructions for completing the process. Further, the memory 504 may include an operating system for performing one or more tasks of the system 500, as performed by a generic operating system in a computing domain. The memory 504 is operable to store instructions executable by the processor 502.

The I/O interface 506 refers to hardware or software components that enable data communication between the system 500 and a network. The I/O interface 506 serves as a communication medium or a communication interface for exchanging information, commands, or data among the various units of the system. The I/O interface 506 may be a part of the processor 502 or maybe a separate component that is implemented by any one or any combination of a digital modem, a radio frequency (RF) modem, an antenna circuit, a WiFi chip, and related software and/or firmware. The I/O interface 506 may be created in software or maybe a physical connection in hardware. The I/O interface 506 may be configured to connect with the display 518, or any other units of the system 500 thereof. The I/O interface 506 may include a connectivity manager for establishing a communication channel between the system 500 and the network. The I/O interface 506 may further take the input from the user via voice input or text input.

In some embodiments, the multi-level IoT activity planner module 508, the dynamic entity identifier module 510, the activity automations generator module 512, the automation-device correlator module 514 may be included within the memory 504. The memory 504 may further include a database to store data. The multi-level IoT activity planner module 508, the dynamic entity identifier module 510, the activity automations generator module 512, the automation-device correlator module 514 may include a set of instructions that may be executed to cause the system 500, in particular, the processor 502 of the system 500, to perform any one or more of the methods/processes disclosed herein. In one or more embodiments, each of the multi-level IoT activity planner module 508, the dynamic entity identifier module 510, the activity automations generator module 512, the automation-device correlator module 514 may be a hardware unit that may be outside the memory 504.

In some embodiments, the system 500 and the related components (processor(s) 502, memory 504, I/O interface 506, and the various modules) may be implemented in a cloud-based environment, such as a cloud-based server in communication with user devices. In some embodiments, the system 500 and the related components may be implemented locally on-device, such as, on device of the users. In some embodiments, the system 500 and the related components may be implemented in a distributed manner, in that, one or more components may be implemented in a cloud-based server while one or more components may be implemented on-device.

In one or more embodiments, the IoT system 516 may be used to automate tasks, monitor and control various processes, and improve the efficiency of the plurality of IoT devices. The IoT system 516 may allow users to control the plurality of IoT devices and systems around their homes by using a smartphone app. In a non-limiting example, by using the IoT system 516, users can control everything from lights and thermostats to security cameras and locks. The IoT system 516 integrates with a wide variety of smart home devices and allows users to create custom automation. The working of the multi-level IoT activity planner module 508, the dynamic entity identifier module 510, the activity automations generator module 512, and the automation-device correlator module 514 will be described below along with detail flow diagram in FIG. 6.

The display 518 is configured to display the content generated by one or more units or components of the system 500. The display 518 may include a display screen. In a non-limiting example, the display screen may be Light Emitting Diode (LED), Liquid Crystal Display (LCD), Organic Light Emitting Diode (OLED), Active Matrix Organic Light Emitting Diode (AMOLED), or Super Active Matrix Organic Light Emitting Diode (AMOLED) screen. The display screen may be of varied resolutions.

FIG. 6 illustrates an operational flow diagram 600 for the generation of dynamic automations involving the plurality of IoT devices, according to one or more embodiments of the present disclosure.

In one or more embodiments, as shown in FIG. 6, the user may provide the voice or text input via the I/O interface 506 to IoT Dynamic Media Environment (MDE) assistant 602 for producing the automations tailored to a specific need through interaction with a voice assistant. Once activated, the IoT MDE assistant 602 communicates with the user, collecting all essential details, and transforms the user's request into structured data format to facilitate subsequent processing. The IoT MDE assistant 602 processes the user's input by utilizing a conversational AI-based large language model (LLM), such as Generative Pre-trained Transformer (GPT) or Bidirectional Encoder Representations from Transformers (BERT) which is combined with a question-answering system to interpret and comprehend user specifications. Further, the IoT MDE assistant 602 may identify the user intent by extracting slots (such as activity descriptions, preferences, device specifications etc.) and resolve any ambiguities through follow-up questions.

The IoT MDE Assistant 602 may serve to facilitate the user interaction, by systematically collecting requisite information to facilitate the creation of the desired IoT Multi-device experience (MDE). Through extensive training on a comprehensive database of user interactions, the IoT MDE Assistant 602 focuses on the extraction of requirements and contextual information from user inputs. The IoT MDE Assistant 602 may employ Transfer Learning from the base language model training and further fine-tune the model to specialize in extracting requirements for specific tasks and activities. The model is specifically configured to elicit additional details through follow-up queries as needed, to better grasp the context or clarify requirements. For instance, when presented with the requirement “Birthday party Guests Welcome,” the IoT MDE Assistant 602 may request information regarding the number of guests, the birthday party's location, and the scheduled time of the event. The IoT MDE Assistant 602 accepts the user's inputs in both textual and audio formats, processes them, and extracts pertinent details in accordance with the user's specifications. These details are subsequently relayed to the Multi-Level IoT Activity Planner module 508 for further processing.

In another embodiment, as shown in FIG. 6, the Multi-Level Activity Planner module 508 may be an optimized Large Language model (LLM) that has undergone extensive training with diverse IoT MDE automation data. The structured output from the IoT MDE Assistant 602 may be inputted into the Multi-level IoT Activity Planner module 508, enabling it to access requirement-related public and proprietary data and interact with a media analyzer 604, should any media, such as audio (song), video (movie), or image, be included in the requirement. The Multi-Level Activity Planner module 508 may dissect the requirements into activities and sub-activities by employing a combination of predefined rules, hierarchical planning techniques, and expert knowledge. The Multi-Level Activity Planner module 508 may take into account various factors, including the user's requirements, available devices, media details, time, location, and environmental conditions.

In an exemplary embodiment, Table 1 shows the various inputs provided by the user to the Multi-level IoT Activity Planner module 508 through IoT MDE assistant 602. In Table 1, the input may correspond to a user query for a specific task (e.g., garden watering automation), and the output may represent a set of activities or actions (e.g., soil moisture check and water regulation) that are required to be performed to complete the task. The Multi-level IoT Activity Planner module 508 may result in the division of the input/requirements from the user into activities and sub-activities and accordingly provide the output based on the obtained result.

TABLE 1

| Input | Output |
|---|---|
| Garden Watering MDE | Soil Moisture Check |
| Automation | Specie based Water Regulation |
| Pre-movie mode automations | Security Measures |
| | Kitchen automations |
| | Movie ambiance |
| | Climate Control |
| Welcoming ambience | Lighting effects |
| | Background music |
| | Decorative projection |
| Complete Gardening | * Automated Watering: |
| Automation | Soil Moisture Check |
| | Specie based Water Regulation |
| | * Control Automations: |
| | Fertilization schedule |
| | Artificial Lighting Automation |
| | Specie based Shade Control |
| | * Plant Monitoring: |
| | Temperature Monitoring |
| | Growth Monitoring |
| | * Notifications |
| | . . . |

In other words, the Multi-Level Activity Planner module 508 may receive the meticulously structured requirement from the IoT MDE Assistant 602 and may formulate and output numerous potential activities, their corresponding sub-activities, and their interdependencies. This process leads to the creation of a comprehensive multi-level IoT activity plan. Utilizing a customized and refined LLM-based model, the planner may dissect the overall requirement into a series of activities. For instance, a request for a “guest welcoming experience for a kid's birthday party” might be deconstructed into individual activities such as “guest arrival,” “guest identification,” “personalized greeting,” “ambient adjustment,” and “cake baking automation,” among others. The Multi-Level Activity Planner module 508 may undergo training with an extensive dataset comprising planned IoT activities and their related sub-activities, covering various intents and sequences of automations, representing an innovative approach in this field. Drawing from the structured user requirement details that may be provided by the IoT MDE Assistant 602, along with supplemental information from public and proprietary sources, the Multi-Level Activity Planner module 508 generates a comprehensive activity plan for the IoT MDE. This plan is subsequently transferred to the Dynamic Entity Identifier module 510 for further processing.

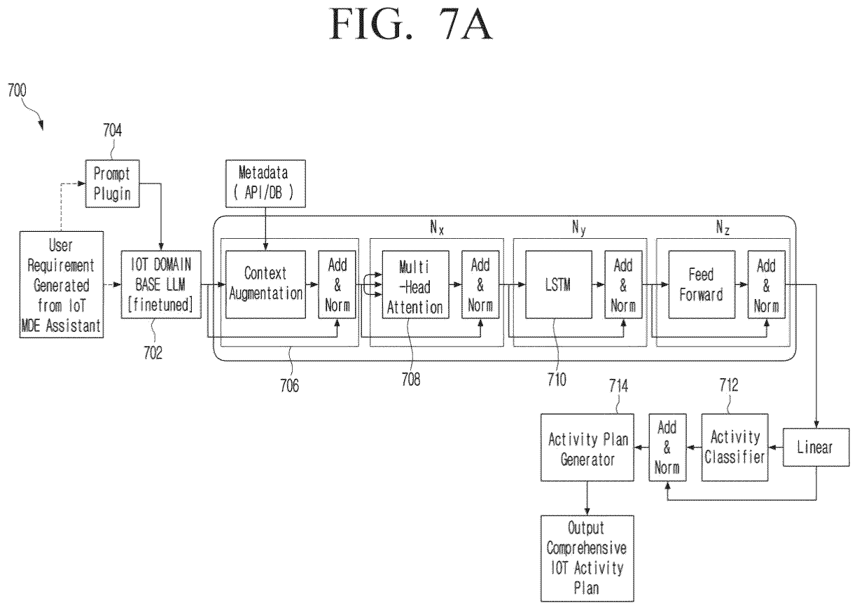

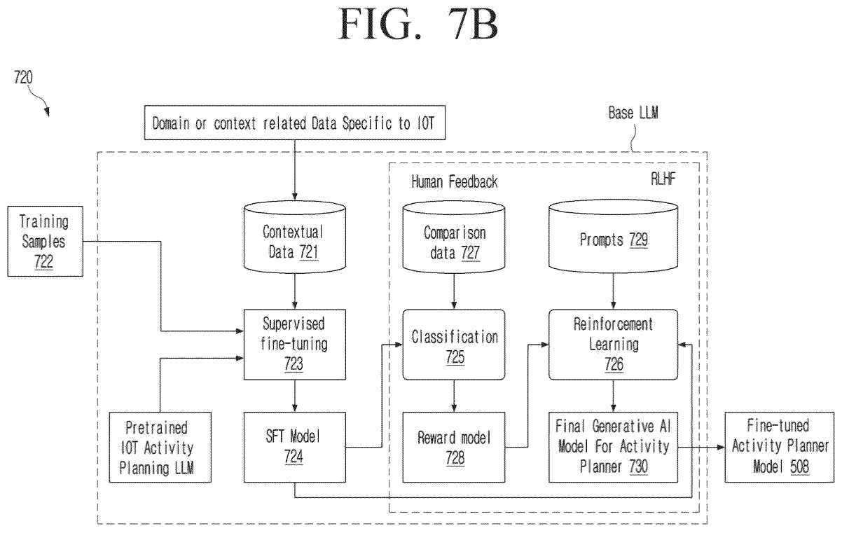

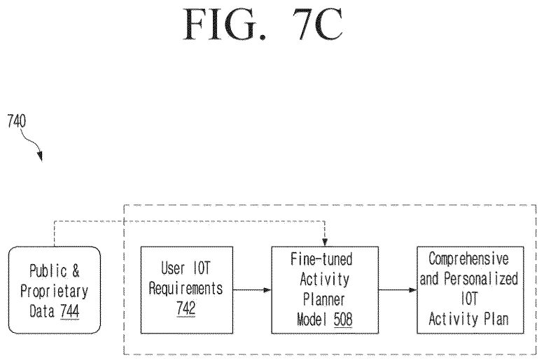

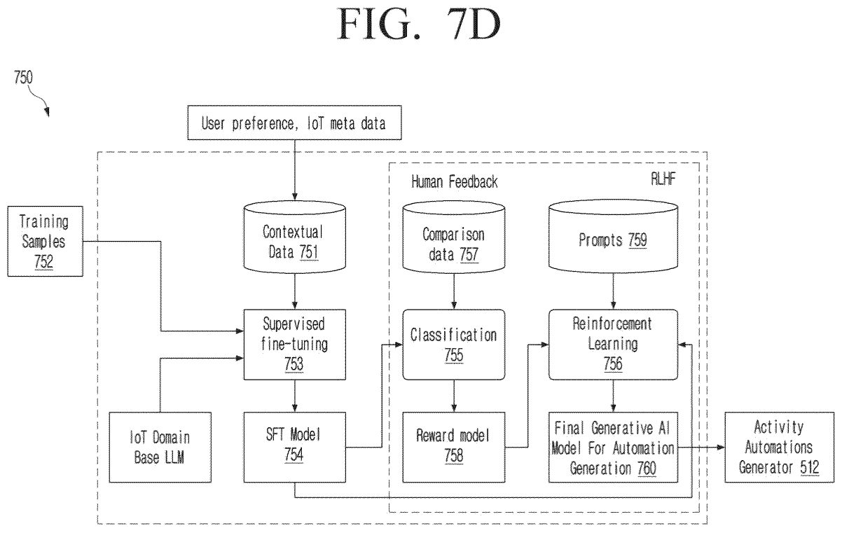

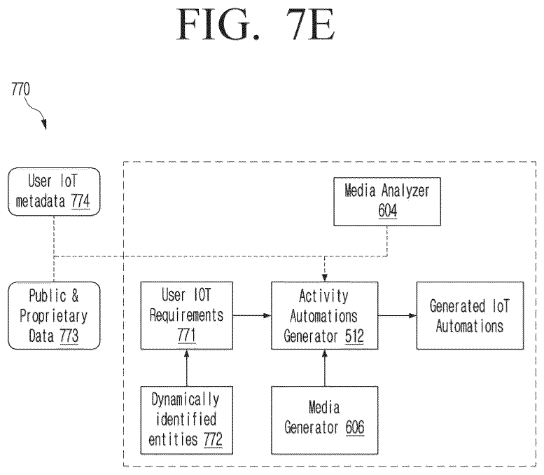

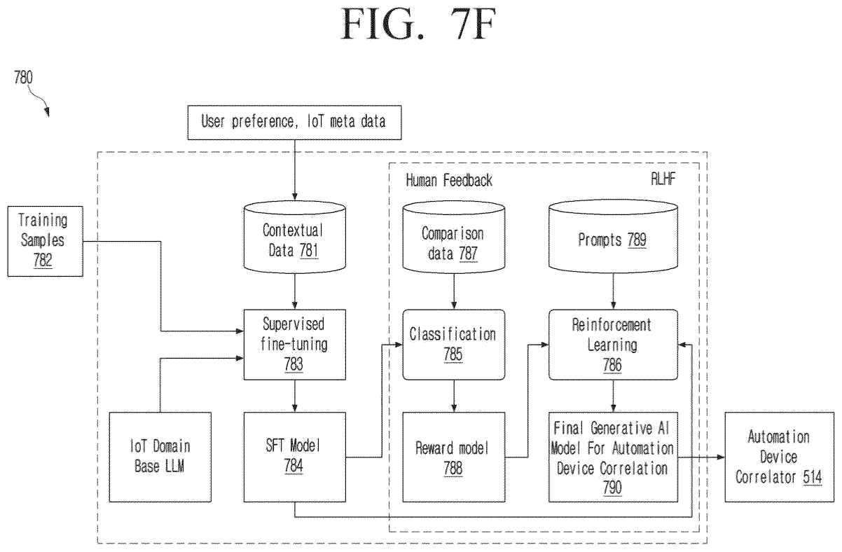

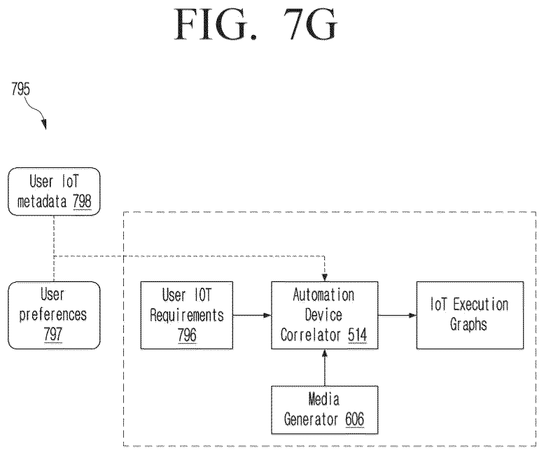

Details regarding the architecture, training and inference of the LLM model associated with the Multi-Level Activity Planner module 508 is explained with reference to FIGS. 7A-7C.

Initially, an IoT domain specific base LLM model may be created. In an embodiment, the base LLM model may be created using an unsupervised fine-tuning on a general purpose foundational LLM. In an embodiment, the unsupervised fine-tuning may be performed using an unsupervised training dataset. The training dataset may include information on IoT devices, capabilities and attributes of IoT devices, IoT automations and routines, user's IoT requirements, as well as a wide range of use-cases, context mappings and non-IOT context to IoT context mapping. The foundational LLM may comprise a plurality of layers L1-Ln. In such an embodiment, the training dataset may be embedded, concatenated, and provided to the foundational LLM. Layers L1-Li (i<n) may be frozen while weights of the layers Li-Ln may be unfrozen, allowing the foundational LLM to adapt and train in the complete IoT ecosystem.

In an embodiment, full fine-tuning or adapter-based fine-tuning may be applied. The full fine-tuning may be defined as changing of original weights of some or all layers of the foundational LLM based on the training data. Further, parameter-efficient finetuning (PEFT) techniques, for example, the adapter-based fine-tuning may include inserting small, trainable adapter layers into an architecture of the foundational LLM, enabling efficient, transfer learning-based adaptation without altering the pre-trained weights of the foundational LLM. Therefore, from the abovementioned operation, the base LLM may be created. Further, in an embodiment, the base LLM with the Multi-Level IoT Activity Planner module 508 may be explained in subsequent paragraphs.

FIG. 7A illustrates the LLM-based model architecture 700, in accordance with an embodiment of the present disclosure. The LLM-based model architecture 700 may be associated with the Multi-Level IoT Activity Planner module 508. FIG. 7B illustrates a block diagram 720 depicting a pipeline for training the base LLM and the Multi-Level IoT Activity Planner module 508 by applying Supervised Fine-Tuning (SFT), Reinforcement Learning from Human Feedback (RLHF), and/or Reinforcement Learning with AI Feedback (RLAIF), according to one or more embodiments of the present disclosure. FIG. 7C illustrates a block diagram 740 depicting a pipeline for inference using the base LLM and the Multi-Level IoT Activity Planner module 508, according to one or more embodiments of the present disclosure.

As seen in FIG. 7A, the IoT domain base LLM (fine-tuned) 702 serves as the foundational processing unit in the architecture of the Multi-Level IoT Activity Planner module 508. The illustrated configuration serves to tokenize and semantically interpret user inputs, thereby achieving initial context-aware embeddings that guide downstream components. Particularly, the base LLM model may be associated with a plurality of components, for example, tokenizer, embedding layer, and transformer layer. The tokenizer may be configured to break down user input into discrete tokens (word and sub-words) that may be processed by the LLM. Further, the embedding layer may be configured to convert each token into a dense vector, facilitating semantic representation. Lastly, the transformer layer may include multi-layer transformer blocks that further contextualize the token proceedings. In one example, a standardized prompt may be generated by a prompting engine 704, as an input that encapsulates both the textual requirements, metadata from the user, additional metadata from IoT MDE Assistant. Further, the output as generated may be context-aware token embeddings and a preliminary IoT activity plan, additional metadata context along with enhanced embeddings.

In an embodiment, the LLM-based model architecture 700 may include a Context Augmentation unit 706. The Context Augmentation unit 706 may be configured to supplement the foundational understanding provided by the Base LLM. The Context Augmentation unit 706 serves to incorporate dynamic, non-IoT related context into the IoT activity planning pipeline. The Context Augmentation unit 706 facilitates preparing the overall activity plan more context-aware and adaptable. The Context Augmentation unit 706 may receive, as input, the output of the Base LLM, which include preliminary planes and context aware token embeddings. Further, the Context Augmentation unit 706 may output augmented embeddings and a refined preliminary IoT activity plan, enriched with real-time non-IoT context. The Context Augmentation unit 706 may be pre-trained on datasets where non-IoT contexts (weather, season, etc.) have influenced IoT activities.

The Context Augmentation unit 706 may include a dynamic context fetcher, a context pre-processor, a dynamic context embedding layer, and a context combiner. The dynamic context fetcher may be configured to obtain dynamic and real time context (e.g. weather, season) that could affect the IoT activity plan. The dynamic context fetcher may analyze the preliminary output from the Base LLM to identify the types of additional contexts that could be useful. Further, the context pre-processor may be configured to clean, normalize, and convert the fetched data into a format supported by the Context Augmentation unit 706. The cleansing and normalizing of the data are performed by data transformation pipelines of layers of the context pre-processor, where the normalization may be configured to bring all features to a common scale.

The dynamic context embedding layer may be configured to convert the pre-processed dynamic context into an embedding vector compatible with the Base LLM output. The dynamic context embedding layer may include a plurality of layers, for example, a Fully Connected Neural Network Layers (FCC), Dropout Layers, and Stacking layer. The Fully Connected Neural Network Layers may generate enriched embeddings to map non-IOT context to IoT context. The Dropout Layers may be added for regularization to prevent overfitting. Lastly, the stacking layer may be deployed above the FCC and the Dropout Layers and captured more complex relationships in dynamic contexts. Further, the context combiner may be configured to integrate the dynamic context embeddings with the contextualized token embeddings from the base LLM. Further, the context combiner may include layers for concatenation or addition to combine embeddings, followed by layer normalization, where the normalization may be added after the combination to stabilize the merged context. Further, a layer normalization may be implemented after the merging of the dynamic context and the Base LLM embeddings to stabilize the composite context.

In an embodiment, the LLM-based model architecture 700 may include a Multi-Head Attention layer 708. The Multi-Head Attention layer refines the initial embeddings generated by the Base LLM and the Context Augmentation unit 706. The Multi-Head Attention layer 708 simultaneously attends to multiple contexts to create a comprehensive and nuanced IoT activity plan. Further, the layer 708 aims to capture various aspects of the IoT scenario such as device interrelationships, action sequence, event triggers, and temporal dependencies. The layer 708 also considers non-IoT contexts like thematic considerations, personal preferences, time of the day, and more to contribute to a comprehensive activity plan. In an embodiment, the Multi-Head Attention layer may include heads, IoT-specific attention heads, non IoT attention heads, feed-forward networks, normalization and activation, final aggregation, and dimensionality reduction.

Further, the multi-head attention layer 708 may receive, as an input, context-aware dense embeddings derived from the Base LLM and the Context Augmentation unit 706. The context aware dense embeddings may contain user intent, preliminary plan along with any accompanying IoT & non-IoT context metadata as an input. Further, the Multi-Head Attention layer 708 may generate a set of refined embeddings, focused on multiple aspects pertinent to IoT and non-IoT contexts as an output to be used for generating a comprehensive IoT activity plan.

In an embodiment, the IoT-specific attention heads may include an IoT attribute identification head (understands attributes associated with IoT devices or activities), a device-device interaction head (attend relationship between IoT devices), an event-action trigger head (coupling events to corresponding actions), a conditional head (conditional statements or requirements of user inputs), a temporal order head (insert time-based information into the embeddings), and a constraints and dependencies head (restrictions or dependencies among IoT devices or activities). In an embodiment, non-IoT attention heads may include theme head, temporal context head, and personal context head.

In an embodiment, the feed-forward networks may enable feature refinement associated with the various heads. The normalization and activation may be configured to be applied for activation stabilization. The final aggregation may concatenate and the linearly transform outputs from all the heads. The dimensionality reduction may be a connected layer used to reduce dimensionality of the concatenated vectors, making them more manageable and efficient for downstream task.

In an embodiment, the LLM-based model architecture 700 may include a long short-term memory (LSTM) unit 710. The LSTM unit 710 may refer to recurrent neural networks (RNNs) for capturing long-range dependencies in sequential data. The LSTM unit 710 may encode temporal relationships between IoT activities and dependencies and make accurate recommendations and decisions for IoT tasks. The LSTM unit 710 may capture the sequential dependencies among features identified by the Multi-Head attention layer 708. The LSTM unit 710 may receive, as an input, encoded sensor readings, weather information, and user activity logs along with metadata from the IoT MDE assistant. Further, the LSTM unit 710 may generate as an output, temporal-sensitive recommendations for IoT activities, updated sensor importance rankings, and other time-related metadata.

Further, the LSTM unit 710 may also include an input gate (to determine information to be stored in a cell state and adding new sensor data or external triggers), forget gate (to remove obsolete information), cell state (store temporal relationships), and output gate (determine relevant information from the cell state).

In an embodiment, the LLM-based model architecture 700 may include an Activity Classifier 712. The Activity Classifier 712 may identify and classify various activities and sub-activities within IoT systems. The Activity Classifier 712 may classify activities at multiple levels of granularity (hierarchical classification) and understand how various activities and sub-activities are interdependent (dependency mapping). For instance, the Activity Classifier 712 may categorize activities into broader types and refine the categories into more specific sub-activities. Further, the Activity Classifier 712 may determine conditional dependencies between activities and sub-activities. The outputs of the LSTM unit 710 and the hierarchical classification output may be concatenated. The input to the Activity Classifier 712 may be the temporally aware embeddings from the LSTM unit 708. The output of the Activity Classifier 712 may be hierarchical and classified activities along with the dependencies.

In an embodiment, the LLM-based model architecture 700 may include an Activity Plan Generator 714 configured to create a detailed and personalized IoT activity plan based on outputs of the preceding layers/units. The Activity Plan Generator 714 takes, as inputs, enriched embeddings from all upstream components, i.e., the Base LLM 702, the Context Augmentation unit 706, the Multi-Head Attention layer 708, the LSTM unit 710, and the Activity Classifier 712. The Activity Plan Generator 714 may output the activity plan including activities, sub-activities, the respective dependencies, and optionally media context. In an embodiment, the activity plan may be represented as a Directed Acyclic Graph (DAG), serialized into a JavaScript Object Notation (JSON) format. A personalized plan is thus created that closely aligns with user preferences and real-world constraints.

As shown in FIG. 7B, contextual data 721 and trained samples 722 can be provided to the base LLM. Supervised fine-tuning 723 may then be performed using a pre-trained IoT activity planning LLM and the training samples 722. The contextual data 721 may relate to domain related data specific to the IoT devices. In an embodiment, Supervised Fine-Tuning (SFT) model 724 may be utilized for fine-tuning. The output of the SFT model 724 may be provided for classification 725 as well as for reinforcement learning 726.

SFT and RLHF are two advanced techniques that can be employed to optimize models built on the base LLM for high accuracy in specialized tasks and activities like the Multi-Level Activity Planner module 508. These techniques offer the model both the depth and breadth of understanding needed to handle the complexity and variability found in IoT environments, thus achieving very high accuracy. The precision and customization can be further improved by incorporating high-quality, comprehensive human feedback and supervised data throughout the training process.

In an embodiment, human feedback may be utilized for training. The human feedback may be provided in the form of comparison data 727. The comparison data 727 may be provided for classification 725 along with the output from the SFT model 724. The output from the classification may be provided to a reward model 728, and further, for reinforcement learning 726. Prompts 729 may also be provided for reinforcement learning. A final generative AI model 730 may process the output of the reinforcement learning and finally the fine-tuned Multi-Level IoT Activity Planner module 508 may be achieved.

As seen in FIG. 7C, during inference, the fine-tuned Multi-Level IoT Activity Planner module 508 may be configured to generate the activity plan. The Multi-Level IoT Activity Planner module 508 may take user requirements 742 as inputs. The Multi-Level IoT Activity Planner module 508 may process the user requirements by fetching public and proprietary data 744. The activity plan may include activities, sub-activities, the respective dependencies, and optionally media context. In an embodiment, the activity plan may be represented as a Directed Acyclic Graph (DAG).

Referring again to FIG. 6, an additional module Media Analyser 604 may fetch and analyse various media forms, extracting relevant context for automation effects generation. The Media Analyser 604 may examine media content and produce contextual automation impacts and associated entities. Further, the Media Analyser 604 employs multi-modal AI models to analyze images, audio, video, speech, and text, leveraging a dataset of annotated media files to understand the context. Upon analyzing the media related to each automation, the Media Analyser 604 generates context and associated entities. This contextual information may subsequently be utilized by the Multi-Level Activity Planner module 508, the Dynamic Entity Identifier module 510, and the Activity Automations generator module 512 to create the desired IoT effects for use in automations. For instance, for an automation requiring a “thunderstorm ambiance,” the Media Analyser 604 would examine relevant audio/video files to understand the elements needed for the ambiance effects, such as thunder sound effects, light dimming, etc.

In another embodiment, as shown in FIG. 6, the Dynamic Entity Identifier module 510 is a custom-trained language model for identifying different entities (may also be referred to as IoT devices or electronic devices) involved in each activity and sub-activity that are crucial for making an effective IoT MDE. The identified entities may include smart home devices (e.g., smart thermostats, smart lights, smart plugs, smart locks, smart security cameras, and smart doorbells), health and fitness devices (e.g., fitness trackers, smart scales, and smart wearables), smart appliances (e.g., smart refrigerators, smart ovens, and smart vacuum cleaners), smart irrigation systems (e.g., smart sprinklers), and environmental sensors (e.g., soil moisture sensors and weather sensors). The Dynamic Entity Identifier module 510 utilizes custom-trained language models to extract the entities relevant to the IoT MDE from the output of the Multi-Level Activity Planner module 508 and the Media Analyser 604. Examples of the entities could be people, devices, music, effects, and other non-living entities. The Dynamic Entity Identifier module 510 may be trained on a variety of datasets, each of which may be a distinct domain containing tagged named entities. For instance, a birthday celebration dataset would have substances, for example, visitors, cake, and beautifications labeled lists. The Dynamic Entity Identifier module 510 may generate a list of the entities as output that may be further passed to the Activity Automation generator module 512 for further processing.

In an exemplary embodiment, Table 2 shows the various inputs based on the activities and sub-activities provided to the Dynamic Entity Identifier module 510. which may provide an output as an entity involved in performing respective activities and sub-activities.

TABLE 2

| Input | Output |
|---|---|
| Soil Moisture Check | Soil Moisture Sensor |
| Temperature Monitoring | Weather Sensor |
| Lighting Effects | Smart Light |
| Guest Identification | Camera |
| | Door bell camera |
| Media synced effects | Smart Lights |
| | Smart AC |
| | Smart Aroma Maker |
| | Smart Projector |
| | . . . |

In another embodiment, as shown in FIG. 6, an additional module Media Generator 606 may be used when the Activity Automations generator module 512, requires the creation of a specific media. Accordingly, the Media Generator 606 may generate personalized media such as audio, images, or animations. The Media Generator 606 may employ deep learning generative multi-modal models to generate the necessary media. For instance, to produce a personalized greeting, the Media Generator 606 may utilize text-to-speech models to create an audio clip saying “Welcome to [User's] movie night.”

In another embodiment, as shown in FIG. 6, the Activity Automations generator module 512 may generate the IoT automations corresponding to each activity and sub-activity. The Activity Automations generator module 512 may take an input by utilizing a generative AI model trained to generate IoT MDE automations, based on the entities from the Dynamic Entity Identifier module 510, planned activities & sub-activities from the Multi-Level Activity Planner module 508, and media analysis from the Media Analyser 604. Optionally, the Activity Automations generator module 512 may also utilize the Media Generator 606 for creating personalized media like images, audio, and videos/animations. For example, personalized & themed audio greetings for the “cartoon character themed Birthday party Guests Welcome” requirement in the form of “Welcome {guest_name}” in voice of the “cartoon character”.

The Activity Automations generator module 512 may be trained on a dataset based on successful IoT automation executions where the dataset includes various entities and their respective automations. The Activity Automations generator module 512 may generate the detailed IoT commands for each automation and may link such commands to the respective triggers. Details regarding the training and inference of the Activity Automations generator module 512 is explained with reference to FIGS. 7D-7E744.

FIG. 7D illustrates a block diagram 750 depicting a pipeline for training the base LLM and the Activity Automations generator module 512 by applying Supervised Fine-Tuning (SFT), Reinforcement Learning from Human Feedback (RLHF), and/or Reinforcement Learning with AI Feedback (RLAIF), according to one or more embodiments of the present disclosure. FIG. 7E illustrates a block diagram 770 depicting a pipeline for inference using the base LLM and the Activity Automations generator module 512, according to one or more embodiments of the present disclosure.

As shown in FIG. 7D, the Activity Automations generator module 512 uses a SFT, RLHF, and/or RLAIF optimized LLM to convert high-level plans and contextual embeddings into actionable IoT automations. This includes triggers, actions, and, optionally, personalized media experiences. The base LLM may be optimized using SFT, RLHF, and/or RLAIF. In the training pipeline, contextual data 751 and trained samples 752 can be provided to the base LLM. Supervised fine-tuning 723 may then be performed. The contextual data may relate to user preferences and IoT meta data. In an embodiment, SFT model 754 may be utilized for fine-tuning. The output of the SFT model 724 may be provided for classification 755 as well as for reinforcement learning 756. By applying Supervised Fine-Tuning (SFT), RLHF, and/or RLAIF, the base LLM can be highly optimized for the specialized tasks and activities required for the generation of dynamic automations.

In an embodiment, human feedback may be utilized for training. The human feedback may be provided in the form of comparison data 757. The comparison data 757 may be provided for classification 755 along with the output from the SFT model 754. The output from the classification may be provided to a reward model 758, and further, for reinforcement learning 756. Prompts 759 may also be provided for reinforcement learning. A final generative AI model 760 may process the output of the reinforcement learning and finally the fine-tuned Activity Automations Generator 512 may be achieved. The use of SFT, RLHF, and/or RLAIF to fine-tune the Base LLM and the Activity Automations Generator 512 would allow generation of IoT automations based on the high-level activity plan. The degree of accuracy and personalization may be enhanced based on the human feedback and supervised data used during the training process.

As seen in FIG. 7E, during inference, the fine-tuned Activity Automations Generator 512 may be configured to generate IoT automations. The Activity Automations Generator 512 may take user requirements 771 as an input. The user IoT requirements 771 may be based on the identified entities 772 that are provided by the Dynamic Entity Identifier Module 510. The Activity Automations Generator 512 may further take public and proprietary data 773 as inputs. The public and proprietary data 773 may relate to use-case specific device attribute values, named entities, media metadata etc. for accurate and personalised automations. The Activity Automations Generator 512 may further take user IoT metadata 774 as input. The user IoT metadata 774 may relate to user specific personalised automations based on user behaviour, devices etc. The Activity Automations Generator 512 may further take personalized media such as audio, images, or animations as input from the Media Generator 606. The Activity Automations Generator 512 may further take activity plan from the Multi-Level IoT Activity Planner 508 as an input. The Activity Automations Generator 512 may further take media analysis from Media Analyser 604 as an input.

Based on the multiple inputs, the Activity Automations Generator 512 may generate detailed automations in the form of a detailed activity plan as an output. The detailed activity plan may include automations in terms of devices, triggers, actions, attributes, and optionally, personalized media. In an embodiment, the detailed activity plan may be in JSON format. With the Activity Automations Generator 512, high-level activity plans can be transformed into device-level instructions (automations).

The detailed and structured automations obtained from Activity Automations generator module 512 may be passed onto the Automation-Device Correlator module 514 for further processing.

In an exemplary embodiment, Table 3 shows the various inputs received based on the entities from the Dynamic Entity Identifier module 510, planned activities and sub-activities from the Multi-Level Activity Planner module 508, and media analysis from the Media Analyser 604. The Activity Automations generator module 512 may provide an output consisting of triggers and actions performed by the entities for the respective input received.

TABLE 3

| Input | Output |
|---|---|
| Automated watering | Watering Automations |
| | Triggers: [Low Soil Moisture Level] |
| | Actions: [Turn on Sprinkler] |
| Party Kitchen setup | Kitchen Automation |
| | Triggers: [Party start time-30 minutes i.e. |
| | 5 pm] |
| | Actions: [Preheat Oven, Turn on icemaker] |
| Pre-Movie setup | Pre-Movie Automation |
| | Triggers_1: [Explicit command by user] |
| | Actions_1: [Play themed music in Smart |
| | Speaker, Perform security check, Turn On |
| | Coffee Maker, Set thermostat to comfortable |
| | temperature] |
| | Triggers_2: [User logs into VR Theatre] |
| | Actions_2: [Play themed music in |
| | headphones, Turn off music in Smart |
| | Speaker, Show movie animations in VR, |
| | Dim Home lights] |

In another embodiment, as shown in FIG. 6, the Automation-Device Correlator module 514 may be configured to analyse capabilities associated with the IoT MDE devices which may be required to execute the automations. Further, based on the IoT MDE devices' capabilities, the Automation-Device Correlator module 514 may be configured to map the automations to the specific IoT MDE devices based on the triggers and actions. The Automation-Device Correlator module 514 may utilize an LLM trained on a large IoT dataset that includes detailed information on a wide variety of IoT devices and their related capabilities. The training input would include details of automations with corresponding triggers and actions along with available user devices with the user preferences mapped to exact device state change for trigger events and actions. Optionally, the Automation-Device Correlator module 514 may utilize the Media Generator 606 for using the generated media to map the execution of media to corresponding automation actions. The Automation-Device Correlator module 514 may further utilize the inputs from user IoT metadata & user preferences.

Further, in the embodiment, the Automation-Device Correlator module 514 may map each automation including triggers and actions to the appropriate IoT devices and may further generate programmable actions as an output. The output is then formatted in the form of IOT execution graphs and further passed on to the consumer LOT System of consumers, (for example SmartThings) to create automations & execute the IoT MDE. As an example, the following dataset can be obtained as can be seen in below provided Table 4.

TABLE 4

| Input | User IOT metadata | User Preference | Output |
|---|---|---|---|
| Type: Watering | [{Type: Moisture | User watering | Triggers: [“Soil |
| Automation | Sensor, | preferences- | Sensor 1”: |
| Trigger: [Low Soil | Name: Soil Sensor 1}, | Duration: 15 min | [Moisture <30%] |
| Moisture Level] | {Type: Sprinkler, | | Actions: |
| Actions: [Turn on | Name: Sprinkler 1}] | | [“Sprinkler 1”: |
| Sprinkler] | | | [Power: On, |
| | | | Duration: 15 min]] |
| Type: Personalized | [{Type: Doorbell | NA | Trigger 1: [“Ring |
| greetings | Camera, | | video doorbell”: |
| Triggers: [Guest | Name: Ring Video | | [Person 1 |
| identification using | Doorbell, | | identification]] |
| doorbell camera] | Place: Entrance}, | | Action 1: [“VA |
| Actions: [Play | {Type: Smart | | Home”: |
| personalized audio in | Speaker, | | [Command: Play, |
| smart speaker, | Name: VA Home, | | Media: |
| Display personalized | Place: Foyer | | Greeting_P1.mp4]] |
| welcome image] | Area}] | | Trigger 2: [“Ring |
| Media Metadata: [ | | | video doorbell”: |
| {Type: Audio | | | [Person 2 |
| Greeting, | | | identification]] |
| Files: | | | Action 2: [“VA |
| [Greeting_P1.mp4, | | | Home”: |
| Greeting_P2.mp4, . . . ]} | | | [Command: Play, |
| {Type: Guest images, | | | Media: |
| Files: Person_P1.jpg, | | | Greeting_P2.mp4]] |
| Person_P2.jpg, . . . }] | | | . . . |

Details regarding the training and inference of the Automation-Device Correlator module 514 is explained with reference to FIGS. 7F-7G.

FIG. 7F illustrates a block diagram 780 depicting a pipeline for training the base LLM and the Automation-Device Correlator module 514 by applying Supervised Fine-Tuning (SFT), Reinforcement Learning from Human Feedback (RLHF), and/or Reinforcement Learning with AI Feedback (RLAIF), according to one or more embodiments of the present disclosure. FIG. 7G illustrates a block diagram 795 depicting a pipeline for inference using the base LLM and the Automation-Device Correlator module 514, according to one or more embodiments of the present disclosure.

As shown in FIG. 7F, the Automation-Device Correlator module 514 uses a SFT, RLHF, and/or RLAIF optimized LLM to map generalized automations to specific IoT devices and provide final automations that can be executed. In the training pipeline, contextual data 781 and trained samples 782 can be provided to the base LLM. Supervised fine-tuning 783 may then be performed. The contextual data may relate to user preferences and IoT meta data. In an embodiment, SFT model 784 may be utilized for fine-tuning. The output of the SFT model 784 may be provided for classification 785 as well as for reinforcement learning 786. In an embodiment, human feedback may be utilized for training. The human feedback may be provided in the form of comparison data 787. The comparison data 787 may be provided for classification 785 along with the output from the SFT model 784. The output from the classification may be provided to a reward model 788, and further, for reinforcement learning 786. Prompts 789 may also be provided for reinforcement learning. A final generative AI model 790 may process the output of the reinforcement learning and finally the fine-tuned Automation Device Correlator 514 may be achieved that can correlate the automations with specific devices and preferences and format the mapped automations to IoT execution graphs.

As seen in FIG. 7G, during inference, the fine-tuned Automation-Device Correlator module 514 may be configured to accept feature vectors representing generalized automations and available IoT devices, correlate the automations with specific devices, and form the mapped automations into IoT execution graphs.

The Automation-Device Correlator module 514 may take details of automations generated by the Activity Automations Generator 512 as an input. The Automation-Device Correlator module 514 may further take detail regarding available IoT devices, user preferences, and device locations as an input. That is, the Automation-Device Correlator module 514 may receive user preferences 797, user IoT requirements 796, and user IoT metadata 798 as inputs. The Automation-Device Correlator module 514 may further take media details from the Media Generator 606 as an input.

Based on the multiple inputs, the Automation-Device Correlator module 514 may output IoT execution graphs: representing the final automations, dependencies, triggers, and state changes. The IoT execution graphs may be formatted in JSON and contain information on mapped devices, their attributes, and state changes necessary for the automations. In an embodiment, the IoT execution graph comprises nodes and edges. The nodes represent a device identified by the corresponding identifiers (IDs). The attribute and value describe the state or condition for the corresponding devices. As an example, the node for ‘Backyard Moisture Sensor’ (device-1) indicates that the device-1 monitors the ‘moisture’ attributes, and the value is ‘low’. Further, the edges represent the relationship between devices characterized by the weight attribute. For example, an edge may link device-1 to another device-2 with a weight of ‘trigger: moisture low->power on’. When the moisture level detected by device-1 is low, the device-2 is triggered to turn on. Accordingly, final automation for execution can be provided.

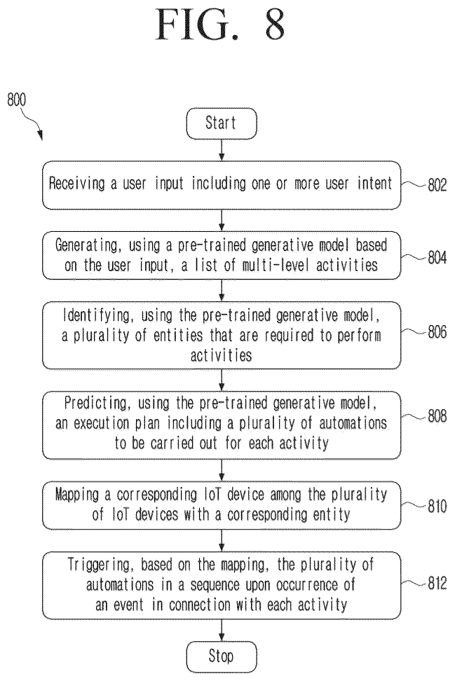

FIG. 8 illustrates a method for creating automations for interactions of the plurality of IoT devices, according to one or more embodiments of the present disclosure.

The method 800 for creating automations for interactions of the plurality of IoT devices (also be referred to as “the method 800” without deviating from the scope of the present disclosure) includes a series of operation steps 802 through 812 of FIG. 8. The operations included in the method 800 may be performed by the one or more components of the system 500, where the processor 502 is controlling each of the respective components of the system 500 using the instructions stored in the memory 504. The method 800 begins at step 802.

At step 802, the method 800 may include receiving the user input including one or more user intent.

In one or more embodiments, Voice Assistant (VA) may possibly be implemented using a generative AI model tailored for IoT domain.

In one or more embodiments, the method 800 may further include determining whether a type of media content is required in the user input. The method 800 may further include identifying, based on a determination that the media content is required by the user input, the type of media content based on the user input required for the corresponding activities. The method 800 may further include generating, using a machine learning model based on the type of the media content, personalized media relevant to each activity. Subsequently, the method 800 may further include generating the plurality of automations varying with time-based on the context of the generated personalized media to be played for each activity. Consequently, the method 800 may further include playing the generated personalized media in the vicinity of one or more of the plurality of IoT devices during the execution of the plurality of automations.

In one or more embodiments, the method 800 may further include the user input that corresponds to at least one of a voice input, a user interaction with user interface (UI), or a text input.

In one or more embodiments, the method 800 may further include determining the one or more user intent by parsing information included in the user input using a generative IoT model. The method 800 may further include determining whether the one or more user intent is clear or unclear about the plurality of automations to be executed. Consequently, the method 800 may include, collecting, upon a determination that the one or more user intent is unclear about the plurality of automations to be executed, additional information from the user related to the plurality of automations to be executed by performing a set of follow-up questions/queries with the user.

At step 804, the method 800 may include generating, using a pre-trained generative model based on the user input, a list of multi-level activities to be executed in connection with the user intent.

In one or more embodiments, the method 800 may further include determining whether the one or more user intent indicates any media content preferred by the user. The method 800 may further include identifying, upon a determination that the one or more user intent indicates a media content preferred by the user, a contextual wording associated with a type of media content for the corresponding activities. Subsequently, the method 800 may include determining a relevant media context corresponding to the type of media content by analyzing metadata associated with one or more media contents, wherein the one or more media contents are similar to the type of media content preferred by the user. The method 800 may include integrating the relevant media context with the corresponding activities. Consequently, the method 800 may include generating the list of multi-level activities based on the integration of the relevant media context with the corresponding activities.

In one or more embodiments, the method 800 may further include identifying a real-time context associated with the user input, wherein the real-time context corresponds to a context that is dependent on the plurality of automations to be executed. The method 800 may further include determining, based on the real-time context using a plurality of neural network transform layers, one or more attributes associated with the plurality of IoT devices, and a context of each of the plurality of automations. The method 800 may further include identifying corresponding dependencies associated with the one or more attributes to perform the corresponding activities. The method 800 may further include classifying the corresponding activities into one or more hierarchical classifiers. Consequently, the method 800 may include generating the list of multi-level activities based on the one or more hierarchical classifiers and the corresponding dependencies.

In one or more embodiments, the method 800 may further include generating, using the pre-trained generative model, the list of multi-level activities based on the user input along with public and proprietary data, where the public and proprietary data corresponds to data available via publicly published data and data relating to corresponding proprietary. The method 800 may further include identifying, using the pre-trained generative model, the plurality of dynamic entities based on a pre-trained dataset along with the public and proprietary data. Consequently, the method 800 may include generating, using the pre-trained generative model, the execution plan based on the pre-trained dataset along with the public and proprietary data.

At step 806, the method 800 may include identifying, using the pre-trained generative model, a plurality of entities that are required to perform activities that are included in the list of multi-level activities. In an embodiment, the activities and related sub-activities may be generated taking into consideration the availability of the device with the user. In another embodiment, the activities and related sub-activities may be generated irrespective of the availability of the device with the user.

In one or more embodiments, the method 800 may further include the plurality of entities including a first set of entities within the user's environment and/or a second set of entities associated with user's IoT environment.

In one or more embodiments, the method 800 may further include the list of multi-level activities that includes a sequence of corresponding activities and a plurality of sub-activities for each activity included in the list of multi-level activities.

In one or more embodiments, the method 800 may further include identifying one or more of the plurality of IoT devices for execution of the plurality of automations for each activity. Consequently, the method 800 may include adapting a state of the one or more of the plurality of IoT devices based on a set of rules defined in the plurality of automations to be executed.

At step 808, the method 800 may include predicting, using the pre-trained generative model, an execution plan including a plurality of automations to be carried out for each activity, based on a relation of corresponding activities in the list of multi-level activities with the plurality of entities for triggering the plurality of automations via the plurality of IoT devices. The execution plan may specify activation times and operational methods for the various IoT devices needed to perform the activities.

In one or more embodiments, the method 800 may further include determining contextual embedding associated with each of the corresponding activities. The method 800 may further include modifying, using the pre-trained generative model, the contextual embedding and the corresponding activities into an actionable sequence. Consequently, the method 800 may include generating the execution plan based on the actionable sequence for executing the plurality of automations via the plurality of IoT devices.

In one or more embodiments, the contextual embeddings refer to contextual data retrieved from the cloud server that includes user historical IoT data and public/proprietary data, along with analyzed/generated media metadata. For instance, in non-limiting examples, the contextual data may include weather predictions, lighting conditions based on date/time, etc. Further, in the embodiment, the contextual data along with activity plan & entity data may be used to create automations i.e. execution plan.

In one or more embodiments, the method 800 may further include retrieving user's IoT metadata in relation to the plurality of IoT devices, wherein the user's IoT metadata relates to personalized attributes of the user corresponding to the plurality of IoT devices. Consequently, the method 800 may include generating the execution plan utilizing the user IoT metadata for executing the plurality of automations via the plurality of IoT devices based on the personalized attributes of the user's IoT metadata.

In one or more embodiments, the method 800 may further include a corresponding trigger time of the corresponding IoT device among the plurality of IoT devices and a corresponding action to be performed after triggering the corresponding IoT device among the plurality of IoT devices at the corresponding trigger time. In an embodiment, the trigger time may refer to one or more of triggers at specified global timestamps and trigger at specific events (such as, timestamp of media playback in a non-limiting example).

In one or more embodiments, the method 800 may further include the pre-trained generative model that corresponds to a model that is generated by training and fine-tuning the base-LLM.

In one or more embodiments, the method 800 may further include generating the pre-trained generative model, the base-LLM is trained and fine-tuned using the SFT process, the RLHF-LLM, and a Reinforcement Learning from Artificial Intelligence Feedback (RLAIF). Further, Retrieval Augmented Generation (RAG) and associated techniques may be used when the model is invoked, such as for inference for each of the components, thereby combining the capabilities of the pre-trained generative model with data sources and search mechanisms.

At step 810, the method 800 may include mapping a corresponding IoT device among the plurality of IoT devices with a corresponding entity among the plurality of entities based on the execution plan.

In one or more embodiments, the method 800 may further include acquiring historical data of the user including a historical user preference for operating the corresponding IoT device among the plurality of IoT devices. The method 800 may further include modifying the execution plan based on the historical user preference for operating the corresponding IoT device among the plurality of IoT devices. Consequently, the method 800 may include mapping the corresponding IoT device among the plurality of IoT devices with the corresponding entity among the plurality of entities based on the modified execution plan.

At step 812, the method 800 may include triggering, based on the mapping, the plurality of automations in a sequence upon occurrence of an event in connection with each activity.

In one or more embodiments, the method 800 may further include determining the occurrence of the event to be a defined change of user activity or IoT device activity.

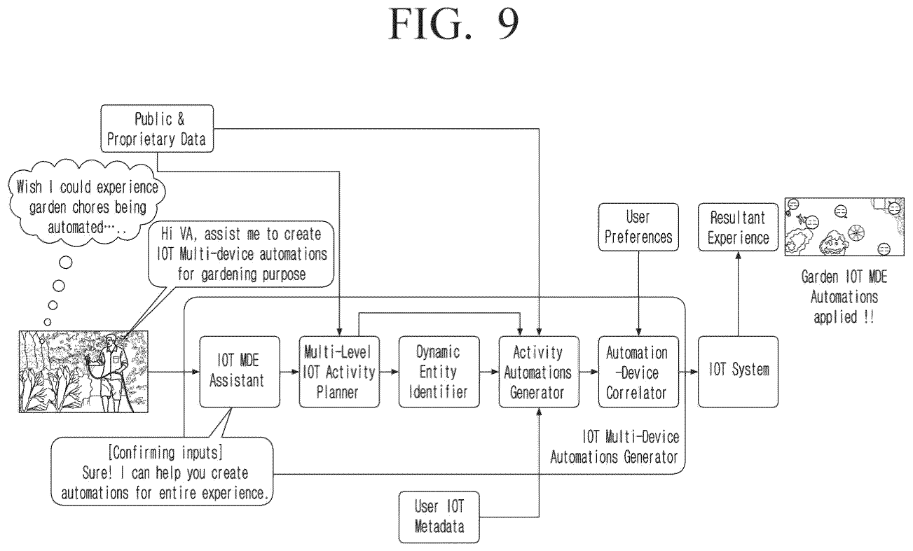

FIG. 9 illustrates a flow diagram of home gardening using IoT MDE Automations Generation, according to an exemplary embodiment of the present disclosure. As can be seen from FIG. 9, the user asks the VA for help to create IoT Multi-device automations for gardening purposes. In return, the VA (may also refer to as IoT MDE assistant 602) asks for more information from the user which may include the queries about type of plants, watering preferences, gardening zones, and weather conditions. The user may accordingly provide the following inputs that the type of plants include Sunflower, Jasmine, and Lawn Grass. Further gardening zones may be zone 1 for the lawn and zone 2 for the sunflowers. In an embodiment, the zones may be auto defined by the system. In an embodiment, the zones may be defined by the user. Furthermore, the weather conditions will be according to the place of Santa Fe California. The VA will further provide this input to the Multi-Level IoT Activity Planner Module 508 (may also referred to as planner). Based on the input received by the planner, the planner will fetch the public and proprietary data, and accordingly generate the activity plan. In an embodiment, the generated activity plan may be adjusted or modified by the user. The activity plan may include various plans like automated watering, control automations, plant monitoring, and notifications. The automated watering plan may include checking for moisture in the soil and species-based water regulation. Similarly, the control automations may include a schedule for fertilizing the soil, artificial lighting automation, and species-based shade control. The plant monitoring plan may include temperature monitoring and growth monitoring.

In the exemplary embodiment, the output of the planner is fed to the Dynamic Entity Identifier Module 510 (may also be referred to as identifier). Based on the input received, the identifier may identify a plurality of entities like types of plant species, a weather sensor, a soil moisture sensor, a sprinkler system, a growth monitoring system, a smart shading device, a pest detector, a pest control system, and a light.

In the exemplary embodiment, the output of the identifier is fed to the Activity Automations Generator Module 512 (which may also be referred to as the generator). Along with the input from the identifier, the generator may further receive inputs from the planner, and the user IoT metadata. Based on the input received, the generator may generate the automations for various plans. The various plans may be like the automated watering plan where the automation will be triggered based on the low soil moisture level and accordingly, the action of turning on the sprinkler is performed. Similarly, for the shade control automation plan where the automation will be triggered based on the temperature being above a predefined threshold and accordingly, the action of activating the shading device along with dimming of the light is performed.

In the exemplary embodiment, the output of the generator is fed to the Automation-Device Correlator Module 514 (which may also be referred to as the correlator). Along with the input from the generator, the correlator may further receive inputs in the form of user preferences. The user preferences may include preferences such as the user watering the plants for a duration of 15 min. Based on the input received, the correlator may correlate automations for various plans. The various plans may be like the automated watering plan where the automation will be triggered when the soil sensor senses that the soil moisture level is below 30%. Accordingly, the action of turning on the sprinkler is performed for the duration of 15 minutes. As a result, home gardening is dynamically automated without any further user interference.

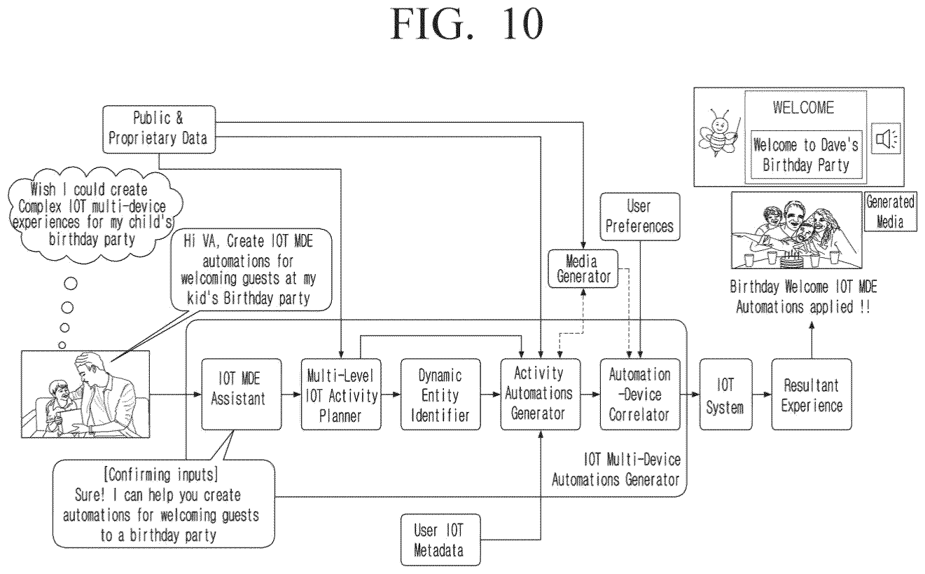

FIG. 10 illustrates a flow diagram of a birthday party using IoT MDE Automations Generation, according to an exemplary embodiment of the present disclosure. As can be seen from FIG. 10, the user asks the VA for help to create IoT Multi-device automations for welcoming guests at user's kid Birthday party. In return, the VA (may also refer to as IoT MDE assistant 602) asks for more information from the user which may include the queries about a location of the birthday celebration, date and time, birthday theme and guests identities. The user may accordingly provide the following inputs that the birthday theme should be based on theme XYZ (for instance, cartoon character). Further, the location of the birthday celebration will be home. Furthermore, the date and time will be 15th August at 5:30 PM. Furthermore, the guests' identities will be a list of guests i.e., a total of 30 guests. The VA will further provide this input to the Multi-Level IoT Activity Planner Module 508 (may also be referred to as planner). Based on the input received by the planner, the planner will fetch the public and proprietary data, and accordingly generate the activity plan. The activity plan may include various plans like a personalised greetings plan, a welcoming ambience plan, a kitchen setup plan, and a climate control plan. The personalised greetings plan may include guest identification and personalised media greeting generated by the Media Generator. Similarly, the welcoming ambience plan may include lighting effects, background music, and decorative projection, Similarly, the kitchen setup plan may include an oven pre-heating and a refrigerator monitoring, wherein the refrigerator monitoring may further include a food temperature control, an inventory tracking and an ice monitoring. The climate control plan may include an AC temperature monitoring, and a humidity monitoring.

In the exemplary embodiment, the output of the planner is fed to the Dynamic Entity Identifier Module 510 (may also be referred to as identifier). Based on the input received, the identifier may identify a plurality of entities: a guest identity, a smart speaker, a door-bell camera, a smart projector, a smart refrigerator, a smart AC, a TV, and a XYZ theme.

In the exemplary embodiment, the output of the identifier is fed to the Activity Automations Generator Module 512 (which may also be referred to as the generator). Along with the input from the identifier, the generator may further receive inputs from the planner, and the user IoT metadata. Based on the input received, the generator may generate the automations for various plans. The various plans may be like the personalized greetings plan where the automation will be triggered based on guest identification using a doorbell camera and accordingly, the action of playing personalized audio in a smart speaker, and display a personalized welcome image is performed. Similarly, for the welcoming ambience plan where the automation will be triggered based on the arrival of 1st guest is identified and accordingly, the action of activating warm colour lights, playing soft background music, showing XYZ projection is performed. Similarly, for the kitchen setup plan where the automation will be triggered based on the party start time-30 minutes i.e. 5 pm and accordingly, the action of preheating oven, and turning on icemaker is performed. Similarly, for the climate control plan where the automation will be triggered based on the party start time-30 minutes i.e. 5 pm and accordingly, the action of turning on AC and setting temperature to 21° C. is performed. In the exemplary embodiment, the output of the generator is fed to the Automation-Device Correlator Module 514 (which may also be referred to as the correlator). Along with the input from the generator, the correlator may further receive inputs in the form of user preferences. The user preferences may include preferences such as the user climate preference of temperature i.e., 21° C.-24° C. and Humidity preference of low based on the input received, the correlator may correlate automations for various plans. The various plans may be like the personalized greetings plan where the automation will be triggered when a person 1 rings video doorbell 3″ and is identified as person 1. Accordingly, the action of play media comprising greeting for e.g., P1.mp4 is performed. As a result, the birthday party is dynamically automated without any further user interference.

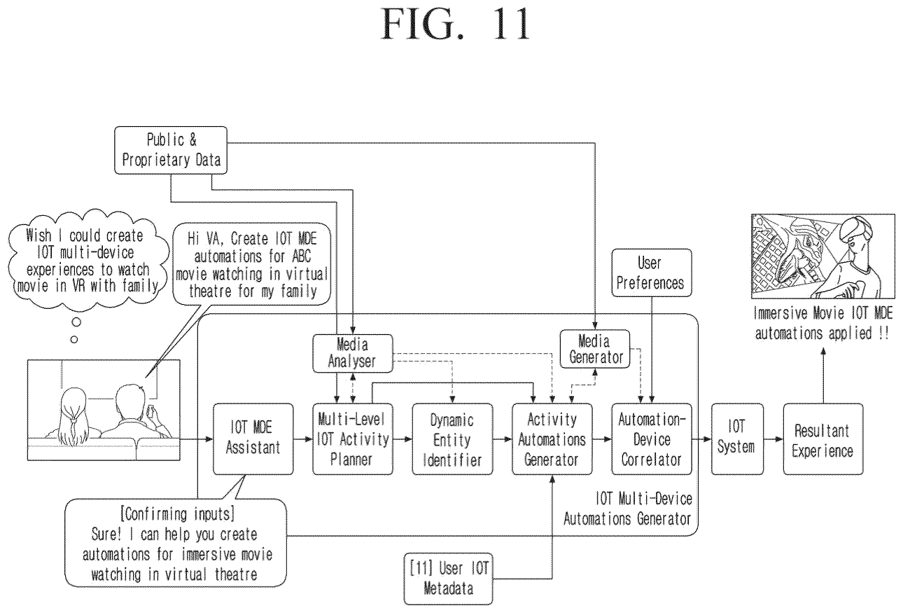

FIG. 11 illustrates a flow diagram of immersive movie experience using IoT MDE Automations Generation, according to an exemplary embodiment of the present disclosure. As can be seen from FIG. 11, the user asks the VA for help to create IoT Multi-device automations for ABC movie (say, HP movie) watching in virtual theatre for my family. In return, the VA (may also refer to as IoT MDE assistant 602) asks for more information from the user which may include the queries about a location for movie watching, theme and family members. The user may accordingly provide the following inputs that the theme should be based on ABC part 3. Further, the location of the movie watching will be home. Furthermore, the family members will be a 4 in number. The VA will further provide this input to the Multi-Level IoT Activity Planner Module 508 (may also be referred to as planner). Based on the input received by the planner, the planner will fetch the public and proprietary data, and accordingly generate the activity plan. The activity plan may include various plans like a pre-movie plan, a movie 1st half plan, an interval plan, and a movie 2nd half plan. The pre-movie plan may include security measures, kitchen automations, movie ambience and climate control. Similarly, the movie 1st half plan may include a media-synced effects and dim lights (Real world). In an embodiment, the media-synced effects may be generated by the Media Generator based on analysis of the media by the Media Analyzer. Similarly, the interval plan may include oven pre-heating, popcorn maker automation and a brighten lights. Further, the movie 2nd half plan may include media-synced effects and dim lights (Real world).

In the exemplary embodiment, the output of the planner is fed to the Dynamic Entity Identifier Module 510 (may also be referred to as identifier). Based on the input received, the identifier may identify a plurality of entities: a smart lock, security system, strong winds, popcorn maker, smart lights, smart air conditioner (AC), light flashes, fishy smell, and aroma maker.

In the exemplary embodiment, the output of the identifier is fed to the Activity Automations Generator Module 512 (which may also be referred to as the generator). Along with the input from the identifier, the generator may further receive inputs from the planner, and the user IoT metadata. Based on the input received, the generator may generate the automations for various plans. The various plans may be like the pre-movie plan where the automation will be triggered based on explicit command by user and accordingly, the action of playing themed music in smart speaker, perform security check, turn on coffee maker, set thermostat to comfortable temperature is performed and/or the pre-movie plan where the automation will be triggered based on user logging into VR Theatre and accordingly, the action of play themed music in headphones, turn off music in a smart speaker, show movie animations in VR and dim home is performed. Similarly, for the movie 1st half plan where the automation will be triggered based on a media playback—HP1 movie timestamp-I or a media playback-HP1 movie timestamp-j and accordingly, the action to set AC fan speed to high—30s, trigger thunder animation outside viewing area— 20s, or the action to Trigger Magic animation—3s, Enable Flash Lighting outside viewing area—2s, Trigger Fishy aroma—5s respectively is performed. Similarly, for the kitchen setup plan where the automation will be triggered based on the party start time-30 minutes i.e., 5 pm and accordingly, the action of preheating an oven, and turning on an icemaker is performed. Similarly, for the interval plan where the automation will be triggered based on the media playback—HP1 movie timestamp—k and accordingly, the action of brighten lights, turn on popcorn maker, etc. is performed. In the exemplary embodiment, the output of the generator is fed to the Automation-Device Correlator Module 514 (which may also be referred to as the correlator). Along with the input from the generator, the correlator may further receive inputs in the form of user preferences. The user preferences may include preferences such as the user climate preference of temperature i.e., 22° C., Humidity preference of medium and the popcorn preference type butter based on the input received, the correlator may correlate automations for various plans. The various plans may be like the pre-movie where the automation will be triggered on a user command. Accordingly, the action at music system based on the user command to play, media i.e., ABC instrumental, from a third-party provider, at the same time action at a security system to change its state to armed state, further, at the same time an action at coffee maker to power on with its mode as latte is performed. As a result, immersive movie experience is dynamically automated without any further user interference.

Referring to the technical abilities and effectiveness of the above-disclosed method and system, the above-disclosed method and system provides the technical improvements like dynamic automations are applied dynamically based on environmental or system changes or changes over time (t) based user's requirement/event in IoT Multi-device environment, which leads to an efficient execution of dynamic automations. Further, dynamic automations can be automatically executed based on the various trigger inputs. Furthermore, dynamic Automations may be applied in any environment based on available IoT devices. Furthermore, an exhaustive set of automations may be generated regardless of device availability, and which can be applied in the virtual environment or the hybrid requirement.

Although specific units/modules have been illustrated in the figure and described above, it should be understood that the system 500 may include other hardware modules or software modules or combinations as may be required for performing various functions.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Those skilled in the art will appreciate that the operations described herein in the present disclosure may be carried out in other specific ways than those set forth herein without departing from essential characteristics of the present invention. The above-described embodiments are therefore to be construed in all aspects as illustrative and not restrictive. The scope of the invention should be determined by the appended claims, not by the above description, and all changes coming within the meaning of the appended claims are intended to be embraced therein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for creating automations for interactions of a plurality of electronic devices, the method comprising:
receiving a user input comprising one or more user intents from a user;
generating, using a pre-trained generative model based on the user input, a list of activities to be executed in connection with the one or more user intents;
identifying, using the pre-trained generative model, a plurality of entities that are required to perform the activities;
predicting, using the pre-trained generative model, an execution plan comprising a plurality of automations to be carried out the activities, based on relations between the activities and the plurality of entities for triggering the plurality of automations via the plurality of electronic devices;
mapping a corresponding electronic device among the plurality of electronic devices with a corresponding entity among the plurality of entities based on the execution plan; and
triggering, based on the mapping, the plurality of automations in a sequence upon occurrence of events in connection with the activities.

2. The method as claimed in claim 1, wherein generating the list of activities comprises:
determining whether the one or more user intents indicate any media content preferred by the user;
identifying, upon a determination that the one or more user intents indicate a media content preferred by the user, a contextual wording associated with a type of the media content corresponding to the activities;
determining a relevant media context corresponding to the type of the media content by analyzing metadata associated with the type of the media content preferred by the user;
integrating the relevant media context with the activities; and
generating the list of activities based on the integration of the relevant media context with the activities.

3. The method as claimed in claim 1, wherein the generating the list of the activities further comprises:
identifying a real-time context associated with the user input, wherein the real-time context is dependent on the plurality of automations to be executed;
determining, based on the real-time context using a plurality of neural network transform layers, one or more attributes associated with the plurality of electronic devices, and contexts of the plurality of automations;
identifying corresponding dependencies associated with the one or more attributes to perform the activities;
classifying the activities into one or more hierarchical classifiers; and
generating the list of the activities based on the one or more hierarchical classifiers and the corresponding dependencies.

4. The method as claimed in claim 1,
determining whether a type of media content is required in the user input;
identifying, based on a determination that the media content is required by the user input, the type of the media content based on the user input required for the activities;
generating, using a machine learning model based on the type of the media content, a personalized media relevant to the activities;
generating the plurality of automations varying with time based on a context of the personalized media to be played for the activities; and
playing the personalized media using one or more of the plurality of electronic devices during execution of the plurality of automations.

5. The method as claimed in claim 1, wherein the generating the execution plan further comprises:
determining contextual embeddings associated with the activities;
modifying, using the pre-trained generative model, the contextual embeddings and the activities into an actionable sequence; and
generating the execution plan based on the actionable sequence for executing the plurality of automations via the plurality of electronic devices.

6. The method as claimed in claim 5, wherein the generating the execution plan further comprises:
retrieving user metadata in relation to the plurality of electronic devices, wherein the user metadata relates to personalized attributes of the user corresponding to the plurality of electronic devices; and
generating the execution plan utilizing the user metadata for executing the plurality of automations via the plurality of electronic devices based on the personalized attributes of the user metadata.

7. The method as claimed in claim 5, wherein the execution plan comprises a corresponding trigger time of the corresponding electronic device among the plurality of electronic devices and a corresponding action to be performed after triggering the corresponding electronic device among the plurality of electronic devices at the corresponding trigger time.

8. The method as claimed in claim 5, wherein the pre-trained generative model is generated by training a base-Large Language Model (base-LLM).

9. The method as claimed in claim 8, wherein, for generating the pre-trained generative model, the base-LLM is trained using a Supervised Fine-Tuned (SFT) process, a Reinforcement Learning from Human Feedback Optimized Language Model (RLHF-LLM), and a Reinforcement Learning from Artificial Intelligence Feedback (RLAIF).

10. The method as claimed in claim 1, wherein the plurality of entities comprises at least one of a first set of entities within the a user environment of the user and a second set of entities associated with a device environment of at least one of the plurality of electronic devices.

11. The method as claimed in claim 1, wherein the user input corresponds to at least one of a voice input, a user interaction with user interface (UI), or a text input.

12. The method as claimed in claim 1, wherein the list of activities comprises a sequence of corresponding activities and a plurality of sub-activities for the activities.

13. The method as claimed in claim 1, further comprising:
identifying one or more of the plurality of electronic devices for execution of the plurality of automations for the activities; and
adapting a state of the one or more of the plurality of electronic devices based on a set of rules defined in the plurality of automations to be executed.

14. The method as claimed in claim 1, wherein the receiving the user input comprises:
determining the one or more user intents by parsing information included in the user input using a generative model;
determining whether the one or more user intents are clear or unclear about the plurality of automations to be executed; and
collecting, upon a determination that the one or more user intents are unclear about the plurality of automations to be executed, additional information from the user related to the plurality of automations to be executed by performing a set of follow-up queries with the user.

15. A system for creating automations for interactions of a plurality of electronic devices, the system comprising:
at least one processor; and
a memory communicatively coupled with the at least one processor, wherein the at least one processor is configured to:
receive a user input comprising one or more user intents;
generate, using a pre-trained generative model based on the user input, a list of activities to be executed in connection with the one or more user intents;
identify, using the pre-trained generative model, a plurality of entities that are required to perform the activities;
predict, using the pre-trained generative model, an execution plan comprising a plurality of automations to be carried out for each activity based on relations between the activities and the plurality of entities for triggering autonomous operations via the plurality of electronic devices;
map a corresponding electronic device among the plurality of electronic devices with a corresponding entity among the plurality of entities based on the execution plan; and
trigger, based on the mapping, the plurality of automations in a sequence upon occurrence of events in connection with the activities.

16. A method for providing artificial intelligence (AI)-based assistance, the method comprising:
receiving a user query that requests a task from a user;
identifying a plurality of activities required to perform the task through an AI-based generative model by inputting a processing result of the user query to AI-based generative model;
identifying a plurality of electronic devices configured to perform the plurality of actions, respectively;
generating an execution plan that indicates activation times and operation methods for the plurality of electronic devices to execute the task; and
transmitting commands to the plurality of electronic devices based on the execution plan.

17. The method of claim 16, further comprising:
inputting the user query to an AI-based language model to obtain a follow-up query to identify user requirements associated with the task;
outputting the follow-up query;
receiving additional information regarding the user requirements from the user; and
obtaining, as the processing result of the user query, context data and the user requirements for the task from the AI-based language model based on the additional information and the user query being input to the AI-based language model.

18. The method of claim 16, wherein the AI-based generative model comprises:
a multi-head attention layer configured to attend to a plurality of contexts included in the processing result of the user query; and
a long short-term memory (LSTM) configured to identify sequential dependencies among features output from the multi-head attention layer.

19. The method of claim 16, wherein the generating the execution plan comprises:
determining contextual embeddings associated with the plurality of activities;
modifying, using the AI-based generative model, the contextual embeddings and the plurality of activities into an actionable sequence; and
generating the execution plan based on the actionable sequence for executing the plurality of activities via the plurality of electronic devices.
